(19) United States
(12) Patent Application Publication
(10) Pub. No.: US 2017/0124118 A1
(43) Pub. Date: May 4, 2017

(54) PORTABLE TERMINAL, SERVER AND INFORMATION UPDATE SYSTEM

(71) Applicants: SHENZHEN FUTAIHONG PRECISION INDUSTRY CO., LTD., Shenzhen (CN); Chiun Mai Communication Systems, Inc., New Taipei (TW)

(72) Inventor: ZUN-YU ZHANG, Shenzhen (CN)

(21) Appl. No.: 15/055,112

(22) Filed: Feb. 26, 2016

(30) Foreign Application Priority Data
Oct. 29, 2015 (CN) 201510714039.4

(51) Int. Cl. G06F 17/30; H04L 29/08; G06K 9/00

(52) U.S. Cl. CPC G06F 17/30256; G06K 9/00268; G06K 9/00255; G06F 17/30268; H04L 67/06

(57) ABSTRACT

An information update system includes a first portable terminal, a server and a second portable terminal. The first portable terminal captures a facial image of a user of the first portable terminal and obtains facial characteristic information and corresponding EXIF information of the facial image. The server stores photo albums and facial characteristic information and corresponding EXIF information of each photo album. The second portable terminal runs an application with a preset background image. The server matches the received facial characteristic information and corresponding EXIF information to the stored facial characteristic information and corresponding EXIF information, and further outputs matching information including at least one of the stored photo albums. The second portable terminal updates the photo album to the application to replace the preset background image.

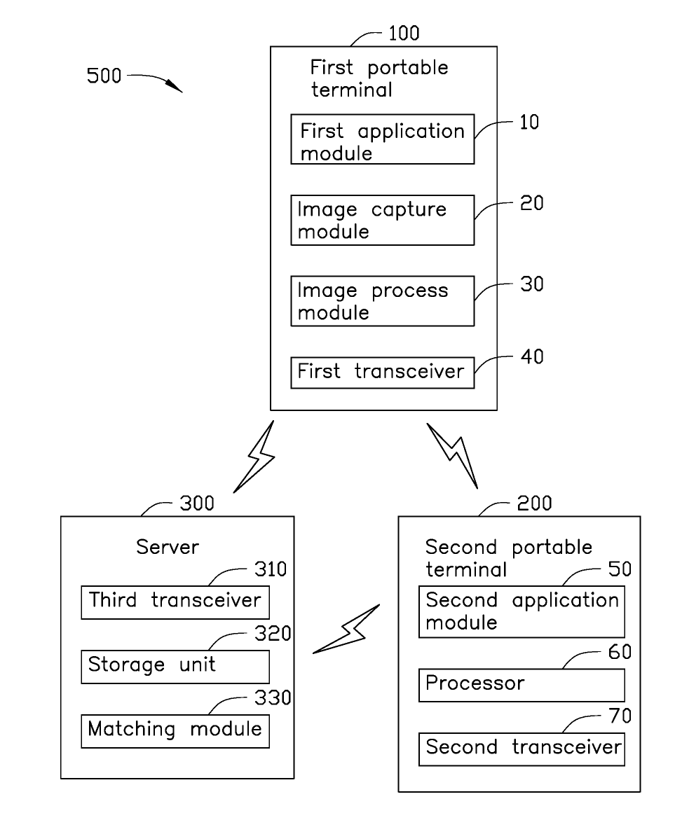

### FIELD

The subject matter herein generally relates to a portable terminal, a server, and an information update system employing the portable terminal and the server for automatically updating information.

### BACKGROUND

Portable terminals may use some applications for exchanging information, such as text and voice, to have conversation easily. However, backgrounds of the applications are usually preset, which is simple and lacks attraction.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

The FIGURE is a block diagram of an exemplary embodiment of an information update system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The FIGURE illustrates an exemplary embodiment of an information update system 500. The information update system 500 includes a first portable terminal 100, a second portable terminal 200 and a server 300, which are wirelessly connected to each other to exchange data and information. Each of the first portable terminal 100 and the second portable terminal 200 may be a smart phone, a tablet computer, a laptop computer, or a personal digital assist (PDA), etc.

The first portable terminal 100 includes a first application module 10, an image capture module 20, an image processing module 30 and a first transceiver 40. The first application module 10 is configured to run applications to exchange information, such as text and/or voice messages, audios, videos, pictures, and photos, etc, with other portable terminals. The application run by the first application module 10 includes a preset background image displayed on a GUI (graphic user interface) of the first portable terminal 100. The image capture module 20 is configured to capture a facial image of the user of the first portable terminal 100. In at least one embodiment, the image capture module 20 can be a front camera. When the user is operating the first portable terminal 100, the face of the user is usually facing a screen of the first portable terminal 100, thus, the image capture module 20 can capture a facial image of the user.

The image processing module 30 is configured to process the facial image to extract facial characteristic information and exchangeable image file (EXIF) information from the facial image. The image processing module 30 analyses the facial image and obtains the facial characteristic information. The EXIF information at least includes a capture date, a capture equipment model, and location data of the facial image. The location data can be such as coordinate data generated by a GPS system, a GLONASS system or a BeiDou Navigation Satellite System (BDS). The first transceiver 40 is configured to transmit and receive information to exchange data with the second portable terminal 200 and the server 300.

The second portable terminal 200 includes a second application module 50, a processor 60 and a second transceiver 70. The second application module 50 is configured to run applications to exchange information, such as text and/or voice messages, audios, videos, pictures, and photos, etc, with other portable terminals. The application run by the second application module 50 includes a preset background image displayed on a GUI of the second portable terminal 200. The processor 60 is configured to update information for the application, such as updating the background image of the application. The second transceiver 70 is configured to transmit and receive information to exchange data with the first portable terminal 100 and the server 300.

The server 300 includes a third transceiver 310, a storage unit 320 and a matching module 330. The third transceiver 310 is configured to transmit and receive information to exchange data with the first portable terminal 100 and the second portable terminal 200. The storage unit 320 is configured to store predetermined facial characteristic information and corresponding EXIF information. In at least one embodiment, the storage unit 320 can be cloud storage. The first portable terminal 100 and the second portable terminal 200 may store local facial characteristic information and corresponding EXIF information to the storage unit 320, such as storing local photo albums to the storage unit 320. The matching module 330 is configured to obtain facial characteristic information and corresponding EXIF information from each of the stored photo albums, and store the facial characteristic information and corresponding EXIF information to the storage unit 320. The stored photo albums may belong to several users, each user may be associated with one or more photo albums, and each photo album may include one or more pictures. The matching module 330 is configured to match received facial characteristic information and corresponding EXIF information to the stored facial characteristic information and corresponding EXIF information, and determine a present user, and further output matching information. The matching information includes a stored photo album of the present user.

The first application module 10 runs a communication application and the second application module 50 runs the corresponding communication application. Thus, the first portable terminal 100 and the second portable terminal 200 establish real-time communication with each other via the communication application so that users of the first portable terminal 100 and the second portable terminal 200 may exchange information.

The image capture module 20 captures a facial image of the user of the first portable terminal 100. The image processing module 30 analyses and obtains facial characteristic information and corresponding EXIF information of the facial image, and further transmits the facial characteristic information and corresponding EXIF information to the server 300 via the first transceiver 40. The third transceiver 310 receives the facial characteristic information and corresponding EXIF information. The matching module 330 matches the received facial characteristic information and corresponding EXIF information to the stored facial characteristic information and corresponding EXIF information of each photo album. When the received facial characteristic information and corresponding EXIF information matches with the stored facial characteristic information and corresponding EXIF information of one photo album, the matching module 330 determines match successful and transmits matching information to the second portable terminal 200 via the third transceiver 310. The matching information includes at least one matched photo album, which may indicate the present user of the first portable terminal 100. The second portable terminal 200 receives the matching information via the second transceiver 70. The processor 60 updates the matched photo album in the matching information to the communication application to replace the preset background image. The second application module 50 dynamically displays the matched photo album as background image of the application.

In other embodiments, the storage module 320 may store several photo albums that are matched successfully. The matching module 330 can compare capture dates in the EXIF information of the several photo albums and obtain a photo album with the latest capture date. Thus, the matching information includes the stored photo album with the latest capture date.

In other embodiments, when the received facial characteristic information is successfully matched with the stored facial characteristic information of a photo album, but the received EXIF information is unsuccessfully matched with the stored EXIF information, the matching module 330 may also transmit the photo album with the matched facial characteristic information to the second portable terminal 200 via the matching information.

In other embodiments, when none of the photo albums is matched successfully, the matching module 330 does not transmit matching information and the second portable terminal 200 does not update the background image of the communication application. In addition, user can operate a setting to use the facial image captured by the first portable terminal 100 as the background image of the communication application run by the second portable terminal 200.

The information update system 500 captures a facial image of the user and obtains facial characteristic information and corresponding EXIF information for being matched, thus to obtain a stored photo album for being updated to the communication application run in the portable terminal as background image. Therefore, the communication application may show the present user in the background image so that there may be a closer association between the users in conversation.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A portable terminal comprising:
an image capture module configured to capture a facial image of a user of the portable terminal; and
an image process module configured to obtain facial characteristic information and corresponding exchangeable image file (EXIF) information of the facial image;
wherein the portable terminal outputs the facial characteristic information and the corresponding EXIF information.

2. The portable terminal as claimed in claim 1, further comprising:
an application module configured to run applications for exchanging information; and
a transceiver configured to transmit the facial characteristic information and the corresponding EXIF information to exchange information with other electronic devices.

3. The portable terminal as claimed in claim 2, wherein the image process module analyses the facial image and obtains the facial characteristic information; the EXIF information includes a capture date and location data of the facial image.

4. A server receiving facial characteristic information and corresponding EXIF information of a facial image, the server comprising:
a storage unit configured to store photo albums and facial characteristic information and corresponding EXIF information of each photo album; and
a matching module configured to match the received facial characteristic information and corresponding EXIF information to the stored facial characteristic information and corresponding EXIF information;
wherein the server outputs matching information according to a match result of the matching module, the matching information includes at least one of the stored photo albums.

5. The server as claimed in claim 4, further comprising
a transceiver configured to receive the facial characteristic information and corresponding EXIF information and transmit the matching information.

6. The server as claimed in claim 4, wherein the stored photo albums belong to several users, each user is associated with one or more photo albums, and each photo album includes one or more pictures.

7. The server as claimed in claim 4, wherein when the received facial characteristic information and corresponding EXIF information are successfully matched to the stored facial characteristic information and corresponding EXIF information of a stored photo album, the matching information includes the matched photo album; when the received facial characteristic information and corresponding EXIF information are successfully matched to none of the stored facial characteristic information and corresponding EXIF information, the server does not output the matching information.

8. The server as claimed in claim 4, wherein when the received facial characteristic information is successfully matched to the stored facial characteristic information, but the received EXIF information is unsuccessfully matched to the stored EXIF information, the matching information includes the matched photo album.

9. The server as claimed in claim 4, wherein when several stored photo albums are successfully matched, the matching module compares capture dates in the EXIF information of the several photo albums and obtain a photo album with the latest capture date, the matching information includes the stored photo album with the latest capture date.

10. The server as claimed in claim 6, wherein when none of the stored photo albums is matched successfully, the server outputs the matching information including the facial image.

11. A portable terminal receiving matching information comprising a photo album, the portable terminal comprising
an application module configured to run an application with a preset background image; and
a processor configured to update the photo album to the application to replace the preset background image;
wherein the application module displays the photo album as background image of the application.

12. The portable terminal as claimed in claim 11, further comprising a transceiver configured to receive the matching information.

13. The portable terminal as claimed in claim 11, wherein when the matching information includes a facial image, the processor updates the facial image to the application to replace the preset background image, and the application module displays the facial image as background image of the application.

14. An information update system comprising:
a first portable terminal configured to capture a facial image of a user of the first portable terminal and obtain facial characteristic information and corresponding EXIF information of the facial image;
a server configured to store photo albums and facial characteristic information and corresponding EXIF information of each photo album; and
a second portable terminal configured to run an application with a preset background image;
wherein the first portable terminal transmit the facial characteristic information and corresponding EXIF information to the server; the server matches the received facial characteristic information and corresponding EXIF information to the stored facial characteristic information and corresponding EXIF information, and further transmits matching information to the second portable terminal according to matching result, the matching information includes at least one of the stored photo albums; the second portable terminal updates the photo album to the application to replace the preset background image and displays the photo album as background image of the application.

15. The information update system as claimed in claim 14, wherein the first application module runs a communication application, the second application module runs the corresponding communication application, the first portable terminal and the second portable terminal establish real-time communication with each other via the communication application.

16. The information update system as claimed in claim 14, wherein the first portable terminal analyses the facial image and obtains the facial characteristic information; the EXIF information includes a capture date and location data of the facial image.

17. The information update system as claimed in claim 16, wherein when the received facial characteristic information and corresponding EXIF information are successfully matched to the stored facial characteristic information and corresponding EXIF information of a stored photo album, the matching information includes the matched photo album; when the received facial characteristic information and corresponding EXIF information are successfully matched to none of the stored facial characteristic information and corresponding EXIF information, the server does not output the matching information.

18. The information update system as claimed in claim 17, wherein when the received facial characteristic information is successfully matched to the stored facial characteristic information of a photo album, but the received EXIF information is unsuccessfully matched to the stored EXIF information, the matching information includes the matched photo album.

19. The information update system as claimed in claim 18, wherein when several stored photo albums are successfully matched, the matching module compares capture dates in the EXIF information of the several photo albums and obtain a photo album with the latest capture date, the matching information includes the stored photo album with the latest capture date.

20. The information update system as claimed in claim 16, wherein when none of the stored photo albums is matched successfully, the server outputs the matching information including the facial image.
